(19) United States
(12) Patent Application Publication
(10) Pub. No.: US 2014/0329229 A1
(43) Pub. Date: Nov. 6, 2014

(54) ABSORBENT DRIED BIOFLUID COLLECTION SUBSTRATES

(71) Applicant: CERES NANOSCIENCES, INC., Manassas, VA (US)

(72) Inventors: Benjamin Lepene, Leesburg, VA (US); Alexis Patanarut, Burke, VA (US)

(21) Appl. No.: 14/357,742

(22) PCT Filed: Nov. 13, 2012
(86) PCT No.: PCT/US2012/064842

§ 371 Date: May 12, 2014

Related U.S. Application Data
(60) Provisional application No. 61/558,085, filed on Nov. 10, 2011.
(60) Provisional application No. 61/558,096, filed on Nov. 10, 2011.

(51) Int. Cl. G01N 1/40

(52) U.S. Cl. CPC G01N 1/405
USPC 435/5; 436/501; 435/7.1; 422/69; 435/287.1

(57) ABSTRACT

A new device and methods that allow for improved sequestration and preservation of harvested analytes and bio-molecules from biofluid samples is defined. The new device and methods relate to an improved dried biofluid collection substrate that is absorbent and contains a plurality of affinity ligands located within defined sample collection regions for enhanced analyte collection and storage. The device and methods allow for simple, safe and reliable ambient temperature collection and preservation of molecules captured from biological and environmental fluids in quantities suitable for analysis and diagnostic testing.

### REFERENCE TO RELATED APPLICATIONS

This application claims an invention which was disclosed in Provisional Application No. 61/558,085, filed Nov. 10, 2011, entitled “Hydrogel capture particle containing dried biofluid collection substrate” and Provisional Application No. 61/558,096, filed Nov. 10, 2011, entitled “Improved Dried Biofluid Collection Substrates”. The benefit under 35 USC §119(e) of the United States provisional application is hereby claimed, and the aforementioned application is hereby incorporated herein by reference.

### FIELD OF THE INVENTION

This invention relates to biospecimen collection tools for the collection, storage and preservation of analytes from biological and environmental samples.

### BACKGROUND OF THE INVENTION

Dried blood spot (DBS) collection card technology is widely accepted sample collection method that provides a facile sample collection method for newborn screening tests, remote location sample collection, drug development research and clinical sample collection. The broad utility, low cost, ability to obtain minimum invasively collected samples and relative ease-of-use of the sample collection methods all contribute to the widespread acceptance of the collection device design. This invention improves upon the ability to collect, preserve, store and analyze biomolecules and analytes using an affinity-based analyte sequestration approach while retaining and expanding upon the simple collection format of current specimen collection paper technology. This invention provides a device for sample collection that can be conducted by a patient at home, in the field as well as in low-resource settings or remote regions with little medical training. Recent advances in analytical technique sensitivity and specificity have furthered the ability to utilize samples collected on DBS paper for health monitoring, disease detection and clinical research. The proposed advancement will allow for the collection of data from molecular biomarkers and other chemical compounds from a wide range of sample matrices using a portable sample collection substrate format.

### SUMMARY OF THE INVENTION

This invention relates to a new device and methods that allow for dried biofluid samples that allows for improved capture, preservation and storage of harvested analytes and biomolecules. The device allows for sample collection and sequestration of molecules present within biofluids in quantities suitable for analysis and diagnostic tests by incorporation of hydrogel capture particles within the collection substrate. The invention is not limited to capillary blood, but can also be utilized for the collection of a wide range of biofluids and environmental samples. Examples of biofluids include: whole blood, serum, plasma, saliva, nasal fluids, sweat, tears and fine-needle-aspirates. Examples of collection card formats include: standard biofluid spot arrays, a swab, and/or dip configuration. The structure and function of hydrogel capture particles (USPTO#7935518) were modified and included as one component of the invention described herein.

### Embodiment

The working embodiment utilizes the following two components:

A. A sample collection substrate and affinity ligands physically or chemically attached to the substrate. Examples of substrate materials include paper, natural and synthetic polymers, electrospun polymers, fabric, non-woven fabrics, inorganic metallic substrates, ceramics and glasses. Examples of substrate formats include collection cards, swabs, or wipes.

B. Optionally, incorporation of Hydrogel capture particles as described by Luchini et al. (Nano Letters 2008). An example of hydrogel capture particles suitable for modification prior to incorporation into the substrate are hydrogel capture particles containing acid black 48 dye molecules covalently bound to the inner particle core structure.

### BRIEF DESCRIPTION OF THE DRAWINGS

FIG. 1 shows a schematic of one embodiment of a device for the collection, preservation and storage of specimen samples. A porous and absorbent sample collection substrate containing a plurality of affinity ligands localized within specific regions.

FIG. 2 shows a schematic of one embodiment of a device for the collection, preservation and storage of specimen samples in accordance with the present invention. An absorbent biospecimen collection substrate in a wipe type format containing affinity ligands.

FIG. 3 shows a schematic of one embodiment of a device for the collection, preservation and storage of specimen samples in accordance with the present invention. An absorbent biospecimen collection substrate in a swab format containing affinity ligands.

### DETAILED DESCRIPTION OF THE PREFERRED EMBODIMENTS

The invention combines the utility of hydrogel capture particles functionalized with affinity ligands and chemical affinity ligands, which are attached directly with a sample collection substrate for specimen storage and transport applications. The sample collection substrates consists of an absorbent layer or matrix containing affinity ligands that bind analytes within a specimen collected from a subject by any convenient methods. The collected specimen is then allowed to dry on the substrate. The affinity ligand containing absorbent substrates allow for specimen storage and transport and enhanced sample preservation of the sample over an extended period of time at elevated temperatures. Additionally the absorbent substrates significantly reduce the volume and mass of the collected specimen sample.

An absorbent substrate material or matrix is one that a specimen sample can either adhere to the surface of the substrate means or matrix or alternatively is taken into the body of the substrate means. By way of example, not limitation the sorbent substrate material may allow the specimen sample to be adsorbed onto its surfaces as with a chemically-modified absorbent metallic, ceramic or glass substrate, or alternatively, the specimen sample by be absorbed into a piece of fabric containing affinity ligands or absorbed into a slab of functionalized polymer gel.

Once the absorbent substrate material has been selected it is treated with the affinity ligands. In the present invention one of the affinity ligands of choice is the hydrogel capture particle, which has been previously chemically functionalized with an affinity dye such as Cibacron Blue F3G-A. To prepare the absorbent substrate material an aqueous suspension containing functionalized hydrogel capture particles is applied to a piece of the absorbent biospecimen collection substrate. The hydrogel capture particle suspension is allowed to dry on the absorbent substrate.

A solution containing affinity dye molecules may be substituted for hydrogel capture particles as the affinity ligands in the above suspension. A solution containing dye molecules to achieve the desired depth of shade is mixed with sodium chloride and sodium carbonate to chemically attach the dye molecules to the absorbent substrate that will receive the specimen sample. Alternatively coupling methods can be utilized to physically or chemically attach alternative affinity ligands to the substrate.

The functionalized absorbent substrate is then stored until used for sampling. It is preferred that the absorbent substrate chemically or physically modified with affinity ligands be stored at room temperature—approximately 25 degrees centigrade—and in the presence of a dessicant. The absorbent substrate or matrix is stable for at least one month. An absorbent substrate material or matrix is one that a specimen sample can either adhere to the surface of the substrate means or matrix or alternatively passively diffuses into the body of the substrate. By way of example, not limitation the sorbent substrate material may allow the specimen sample to be adsorbed onto its surfaces as with a sheet of chemically-modified glass, or alternatively, the specimen sample by be absorbed into a piece of fabric containing affinity ligands or absorbed into a slab of functionalized polymer gel.

### EXAMPLES

### Example 1

A 15 microliter aliquot of serum sample is dropped onto a piece of absorbent substrate of dimensions of approximately 4 mm by 8 mm. The absorbent substrate had been previously treated with an aqueous suspension of a synthetic polymeric matrix derivatized with Cibacron Blue F3G-A. After application of the serum sample to the absorbent substrate, the sample was stored at ambient temperature until extraction prior to analysis.

Elution of the target analytes from the sample and testing for the type of target analytes sequestered by the pretreated absorbent substrate were accomplished by first placing the entire substrate sample into a 1.5-mL microcentrifuge tube. Fifty microliters of a solution comprising 0.1 molar sodium chloride was added to the microcentrifuge tube. The microcentrifuge tube was then gently agitated at ambient temperature for 30 minutes to elute the sequestered target analytes from the absorbent substrate.

At the conclusion of the elution period 30 microliters of the target analyte containing 0.1 molar sodium chloride supernatant was analyzed via SDS PAGE and visualized by silver staining to determine the target analytes sequestered from the original serum sample.

### Example 2

A 15 microliter aliquot of serum sample is dropped onto an absorbent substrate of dimensions of approximately 4 mm by 8 mm. The absorbent substrate was previously treated with an aqueous suspension of a synthetic polymeric matrix derivatized with Reactive Blue 4. After application of the serum sample to the absorbent substrate, the sample was stored at ambient temperature until processed for the elution of the lysozyme from the sample and testing for lysozyme activity retention.

Elution and testing of the sequestered and preserved lysozyme was accomplished by first placing the entire sample into a 1.5-mL microcentrifuge tube. 400 microliters of 0.3 molar sodium chloride solution was added to the microcentrifuge tube. The microcentrifuge tube was then gently agitated at room temperature for 30 minutes to elute the lysozyme from the sample.

After elution, a micropipette was used to separate the lysozyme containing sodium chloride supernatant from the solid substrate. The entire volume of the supernatant was added to 5 milliliters of a suspension of 0.5 milligrams per milliliter Micrococcus luteus cells. The turbidity of the Micrococcus luteus suspension was monitored for one hour at 450 nanometers at room temperature. The final turbidity was then compared to the standard for a determination of lysozyme activity retention in the original sample at the conclusion of the storage period.

### Example 3

This example compares the level of lysozyme activity retention in serum samples stored for 30 days at ambient temperature (approximately 20 degrees C.) and at 37 degrees C. with >90% humidity.

Liquid serum samples were obtained by any convenient method. A 15 microliter aliquot of serum sample was dropped onto two types of absorbent substrates of dimensions of approximately 4 mm by 8 mm: unmodified 3MM chromatography paper and 3MM chromatrography paper previously treated with an aqueous suspension of a synthetic polymeric matrix derivatized with Reactive Blue 4.

The first set of samples was stored at ambient temperature. The second set of samples was stored at 37 degrees C. with >90% humidity.

At approximately the same time every 10 days for the next 30 days, one sample of each substrate type from both sample sets was analyzed for lysozyme activity retention. Analysis of the sequestered and preserved lysozyme were accomplished by first placing the entire sample into a 1.5-mL microcentrifuge tube. To the microcentrifuge tube was added 400 microliters of a solution of 0.3 molar sodium chloride. The microcentrifuge tube was then gently agitated at room temperature for 30 minutes to elute the lysozyme from the sample.

After elution, a micropipette was used to separate the lysozyme containing sodium chloride supernatant from the solid substrate. The entire volume of the supernatant was added to 5 milliliters of a suspension of 0.5 milligrams per milliliter Micrococcus luteus cells. The turbidity of the Micrococcus luteus suspension was monitored for one hour at 450 nanometers at room temperature. The final turbidity was then compared to the standard for a determination of lysozyme activity retention in the original sample at the conclusion of the storage period.

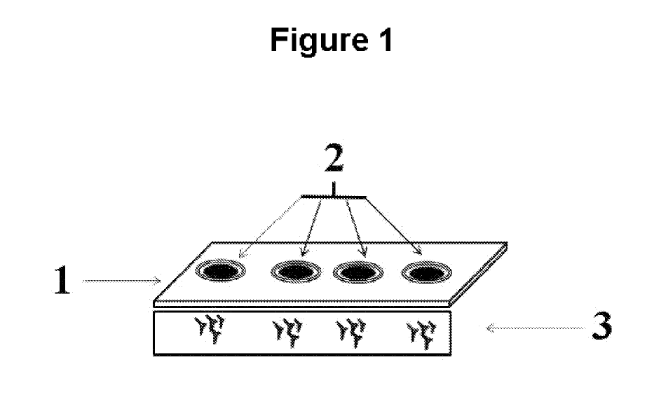

FIG. 1 shows a type of specimen card that can be utilized as an absorbent collection substrate. The specimen collection card is commercially available from a variety of sources, including Whatman, Inc., and Schleicher & Schuell. The specimen collection cards usually have the dimensions of either 3 inches by 4 inches, or 5 inches by 7 inches. However the size of the filter paper is selected primarily for ease of transportation and storage and may be of any size without affecting the present method of the invention. The type of specimen card as an example is shown in FIG. 1 is a Schleicher & Schull #903 3 inches by 4 inches card with pre-printed circles (2) treated with affinity ligands (3) to provide application sites adapted for the sequestration and storage of target analytes in biospecimen samples. It is preferred that the technician collecting the sample locate the specimen sample within the circles (2). Each collection circle or region may contain one or more affinity ligands designed to capture specific analytes, sets of analytes or classes of analytes. There is also space on the card available for the technician collecting the specimen sample to write the patient's identification information. Alternatively, barcoding, radio frequency identification tags, global positioning system devices or other means of coding can be utilized for sample identification and tracking.

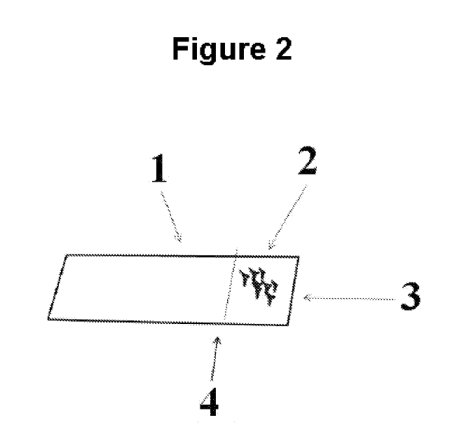

An absorbant biofluid wipe containing affinity ligands is shown in FIG. 2. As shown in FIG. 2, the sample collection wipe substrate comprises a hand-contact surface for manipulating the wipe (1) and an analyte harvesting region (3) which is treated with affinity ligands (2). The delineation (4) in FIG. 2 shows the division between the sample collection wipe substrate and the analyte harvesting region. The material from which the biofluid wipe is constructed preferably has high resistance to seepage to permit the hand-contact surface to remain dry for the duration of the biospecimen or environmental sample collection, preservation and storage process.

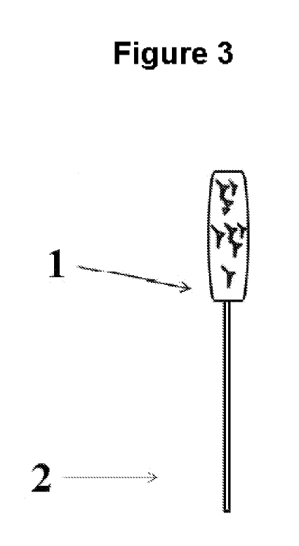

FIG. 3 shows the preferred embodiment of a swab for biospecimen sample collection (1). As shown in FIG. 3, the swab includes a handle (2) having a proximal portion and a distal portion including a distal end. The term “distal” is meant to refer to the end of the handle that is furthest from the technician holding the swab, whereas the term “proximal” is meant to refer to the end that is closest to the technician holding the swab. A swabbing tip (1) that was previously treated with affinity ligands is provided on the distal end for contacting and collection the biospecimen sample. The swabbing tip may be formed of an absorbent substrate such as cellulose cotton fibers and is softer and more resilient than the handle. It is preferred that the swabbing tip have a convex shaped surface for biospecimen sample collection.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

I claim:

1. A method for biospecimen collection and ambient temperature storage comprising at least steps of:
(a) contacting the absorbent sample collection substrate with a solution comprising the desired affinity ligand(s) for facilitating target analyte collection, sequestration, and storage;
(b) evaporating said solution to present an absorbent sample collection substrate having said means for target analyte collection, sequestration, and storage;
(c) applying a specimen sample to said sample collection substrate such that the target analyte in said specimen sample is sequestered by said sample collection substrate; and
(d) using an extraction solvent or buffer to separate said sequestered target analyte from said absorbent collection substrate.

2. The method as claimed in claim 1, wherein the absorbent sample collection substrate is selected from the group comprising of the following: cellulose fiber, cotton fiber, paper, natural polymeric matrices, synthetic polymeric matrices, inorganic fibers and structures, gels, proteins or collagen networks.

3. The method as claimed in claim 1, wherein the specimen sample is a biological or environmental specimen selected from the group comprising of one of the following: urine, blood, plasma, saliva, tears, sweat, synovial fluid, cerbrospinal fluid or aqueous solutions containing small organic molecules.

4. The method as claimed in claim 1, wherein the target analyte is selected from the group comprising of the following: metabolites, proteins, RNA, micro RNA, DNA, glycoproteins, lipids, glycolipids, proteolipids, hormones, cytokines, growth factors, biomarkers, virus particles, bacteria, fungi, drug compounds, synthetic organic compounds, volatile odorants, toxicants and pollutants.

5. The method as claimed in claim 1, wherein the analyte is extracted by physical or chemical means.

6. A biospecimen collection device for isolating and preventing degradation to an analyte mixture comprising:
an absorbent biospecimen collection substrate containing chemically or physically bound affinity ligands for analyte sequestration within the substrate;
wherein the analyte is selected from a group comprising of metabolites, proteins, RNA, micro RNA, DNA, glycoproteins, lipids, glycolipids, proteolipids, hormones, cytokines, growth factors, biomarkers, virus particles, bacteria, fungi, drug compounds, synthetic organic compounds, volatile odorants, toxicants and pollutants; and
wherein the affinity moiety is selected from the group comprising of: affinity dyes, drug compounds, metabolites, negatively charged monomers, positively charged monomers, hydrophobic surfaces, hydrophilic surfaces, sulfonic acid groups, nucleic acids, glycopeptides and glycoproteins.

7. The device of claim 6, wherein said porous substrate is comprised of cellulose fiber, cotton fiber, paper, natural polymeric matrices, synthetic .polymeric matrices, inorganic fibers and structures, gels, proteins or collagen networks.

8. The device of claim 6, wherein said affinity moieties are distributed across delineated zones or regions within the substrate.

9. The device of claim 6, wherein a plurality of affinity capture zones are present within said substrate containing one or more combinations of affinity moieties.

10. The device of claim 6, configured as a sample collection substrate, surface, swab or a wipe.

11. A biospecimen collection device for isolating and preventing degradation to an analyte mixture, comprising:
an absorbent biospecimen collection substrate containing a polymeric matrix impregnated within the substrate;
wherein the polymeric matrix has a pore size that under certain conditions allows for the analytes to enter the matrix while excluding other compounds from the mixture from entering the matrix;
wherein the polymeric matrix contains chemically or physically bound ligands having high affinity for a set of analytes;
wherein the analytes are selected from a group comprising of metabolites, proteins, RNA, micro RNA, DNA, glycoproteins, lipids, glycolipids, proteolipids, hormones, cytokines, growth factors, biomarkers, virus particles, bacteria, fungi, drug compounds, synthetic organic compounds, volatile odorants, toxicants and pollutants; and
wherein the affinity ligands are selected from the group comprising of: affinity dyes, drug compounds, metabolites, negatively charged monomers, positively charged monomers, hydrophobic surfaces, hydrophilic surfaces, sulfonic acid groups, nucleic acids, glycopeptides and glycoproteins.

12. The device of claim 11, wherein said absorbent substrate is comprised of cellulose fiber, cotton fiber, paper, natural polymeric matrices, synthetic .polymeric matrices, inorganic fibers and structures, gels, proteins or collagen networks.

13. The device of claim 11, wherein said affinity ligands are distributed across delineated zones or regions within the substrate.

14. The device of claim 11, wherein a plurality of affinity capture zones are present within said substrate containing one or more combinations of affinity ligands.

15. The device of claim 11, configured as a sample collection substrate, surface, swab or a wipe.
